(19) United States
(12) Patent Application Publication
(10) Pub. No.: US 2007/0168063 A1
(43) Pub. Date: Jul. 19, 2007

(54) Programmable tone control filters for electric guitar

(76) Inventors: Robert Alan Gallien, Los Gatos, CA (US); Kevin Arthur Robertson, Santa Barbara, CA (US)

Correspondence Address: Michael L. Harrison, Suite 250, 16400 Lark Avenue, Los Gatos, CA, 95032, US

(21) Appl. No.: 11/334,826

(22) Filed: Jan. 18, 2006

(51) Int. Cl. G06F 17/00

(52) U.S. Cl. 700/94; 381/118

(57) ABSTRACT

A method and apparatus for simulating the characteristics of an analog tone control circuit using digital computation means. The desired analog tone control circuit is modeled using initial treble, middle, and bass settings, following which simulation software is used to generate the model's magnitude and phase responses versus frequency, extending over the desired frequency range. Gains, zeroes and poles are then chosen to produce magnitude and phase versus frequency response matching as closely as possible to that of the simulated circuit. A bilinear transformation is then performed to produce a digital filter prototype. Update equations responsive to treble, middle, and bass settings of the simulated tone control circuit are then designed in a specified form, providing for modification of the digital filter parameters as a function of updates in the treble, middle, and bass settings of the simulated tone control circuit.

Applicant hereby claims the benefit of the earlier filing date of the Provisional Application for Patent of ROBERT A. GALLIEN and KEVIN ROBERTSON, entitled PROGRAMMABLE TONE CONTROL FILTERS FOR ELECTRIC GUITAR, filed Jan. 18, 2005, No. ______

### BACKGROUND OF THE INVENTION

1. Field of the Invention

The present invention relates to audio amplification systems and audio signal processing. In particular, the present invention concerns a method and apparatus for accurately simulating analog tone control circuits having desired frequency response and phase characteristics over a desired frequency range, using digital computation means, such as a digital signal processor or general-purpose microprocessor, in order to accurately simulate the characteristic sound of a variety of analog tone control circuits.

### Prior Art Background

It is well known to amplify musical instruments for the purpose of increasing their volume. Electric guitars, and similar instruments, use transducers to convert the vibrations of the strings into electrical signals which are then sent to an amplifier in order to increase the magnitude of the signals to levels sufficient to drive loudspeakers.

The guitar and amplifier together, along with the speakers, create a combination instrument having unique tonal characteristics, the amplifier serving the purpose of not only increasing the signal level but, through its own inherent characteristics, modifying the tonal balance and the harmonic structure of the amplified signal.

The need to adjust the amplification of different frequencies of sound has long been recognized. Initially, adjustment of frequency response was used for the purpose of remedying deficiencies in the frequency responses of various components in the guitar, amplifier, and speaker chain. Later, it became known for its original purpose, and as a technique for deliberately modifying the amplifier's amplification of various frequencies and frequency ranges, in order to produce a variety of audible effects.

As a result, tone control circuits have become a standard fixture of most audio amplifiers, and it is well known to add to equipment used for amplification purposes tone control and other tonal enhancement circuits that modify, as a function of frequency, the tonal characteristics of the guitar, amplifier, and speaker combination.

The amplifiers also frequently contain circuits for processing the signal in a variety of ways to modify the resultant sound; in addition to tone shaping, signals are given controlled distortion and similar effects.

A modern amplifier's circuitry may contain a number of specialized circuits for these purposes, including, in addition to tone control circuits and other tonal characteristics equalization or enhancement circuits, over-driven amplifier stages, and the like. The resulting sound is a complex product of the guitar's own signal characteristics, as modified by the amplifier circuits and the tonal colorations added by loudspeakers and enclosures.

The present invention is concerned with only the tone control circuits of the amplifier.

The conventional prior art analog tone control circuit is either the circuit shown in FIG. 1, or a variation of it. FIG. 1 itself is the simplified schematic of a tone control circuit, or “tone stack,” that has been used for many years in amplifiers such as the “Twin” amplifier, manufactured and sold since the 1950's by Fender Musical Instruments Corp. The circuit is still in widespread use, in its original form as well as in the form of a number of variations, several of which varieties are illustrated in FIG. 2, FIG. 3, and FIG. 4.

Variations in the conventional analog circuit include changes in both circuit wiring configurations, such as those illustrated in FIG. 2, FIG. 3, and FIG. 4, and changes in component values.

Slight changes in the configuration of the wiring, with or without changes in component values, can produce wide variations in the tonal qualities produced by the circuits. Likewise, changes in component values, with or without changes in the configuration of the wiring, can also produce wide variations in the tonal qualities produced

Because each variant of a tone control circuit shapes the frequency response of the amplifier in a unique way, amplifiers can be tailored to work optimally for a particular music style by choosing a particular tone stack. If a performer wants to create several music styles the performer must own many amplifiers, which is inconvenient and costly.

As a result, it has been recognized that it would be desirable for an amplifier to have tone control circuits capable of adjustment or reconfiguration to allow the tonal characteristics of the amplifier to simulate a wide range of different tone control circuits.

Simulation of a programmable tone control circuit by programmable digital filters has been done with some degree of success. However, a problem with achieving the wide range of tone control characteristics desired is that each change in the wiring or the component values of the circuit being simulated produces a complex interaction among the circuit components. The exact frequency response characteristics of even the basic tone control stack are difficult to analyze. (See e. g., discussion in Curtis, U.S. Pat. No. 6,222,110 B1). The changes that cause this interaction in the model circuit, and that make accurate analysis difficult, also make simulation difficult.

Curtis, U.S. Pat. No. 6,222,110 B1, teaches one solution to the problem: simulation of a plurality of tone control circuits by use of a programmable digital filter circuit whose characteristics are controlled by data that is obtained by measurement of the response of the actual tone control circuit that it is desired to simulate. After the model circuit has been measured, and the data points determined, that data is used to control a programmable digital filter to cause it to approximate the same frequency response characteristics as that of the model circuit. In theory, enough data points could be obtained to cover the entire desired control range without significant gaps between adjacent data points. In practice, though, in order to make the process of measurement and storage more manageable, the data actually acquired is limited; measurements are made of the model circuit only at at selected, spaced-apart settings of the model circuit's tone controls.

Curtis stores these data points for later retrieval, when they are called on to control the programmable filters of the Curtis tone control. If it is desired to reproduce settings of the model circuit tone controls for which settings data points exist, data points corresponding to those settings are used, without modification, to program the programmable digital filter circuit. When settings are desired that are in between those actually measured, Curtis employs 3D interpolation to derive intermediate values from the stored data points.

With sufficient available data storage, Curtis can simulate a plurality of tone control circuits using this measure-store-interpolate method.

Although data interpolation is a common method for providing reasonably continuous control over a wide range of settings, it is not as satisfactory as would be a more general solution, such as using a generally applicable mathematical model. It is known in the filter art to use more general methods, and a standard method of modeling the circuit of FIG. 1, for example, is accomplished by applying the method of Kirchhoff's Laws and Laplace Transforms to obtain a transfer function which describes the frequency response of the circuit in terms of the circuit elements.

The general method described would yield a rigorous solution to the problem, if it could be carried out in practice. However, it is recognized as a limitation of the method that it is difficult to find an exact transfer function in terms of circuit elements for the circuit of FIG. 1, and its variants, because, as described above, the elements of the circuit interact with each other in many ways. Because of these interactions, if the method were exactly done, the expression for the transfer function would contain a large and unwieldy number of terms. As a result, it is impraticably difficult to model the circuits exactly, and to design equivalent digital filters with exact magnitude and phase response.

A need exists therefore for a method and apparatus for providing practical, realizable filters that overcome the problems outlined above.

Accordingly, it is an object of this invention to develop approximate filters, which accurately model a wide range of tone control circuits in terms of magnitude and phase response, for all possible tone control settings.

It is another object of this invention is to implement the models using digital filters, which produce magnitude and phase responses that are near exact matches to the magnitude and phase responses of a wide range of tone control circuits, for all possible tone control settings.

A further object of this invention is to include the digital filters in a programmable amplifier, to produce magnitude and phase responses that are near exact matches to the magnitude and phase responses for a wide range of tone control circuits.

### BRIEF SUMMARY OF THE INVENTION

The present invention accomplishes the above and other objects by providing a versatile digital tone control filter derived by first representing the desired analog tone control circuits, set at initial settings, by an analog filter approximation using summed low-pass and high-pass analog filters, then deriving equivalent digital filters from the approximation by using bilinear transforms, and using update equations to adjust the characteristics of the digital filters for all tone control settings.

In accordance with the present invention's method, the desired analog tone control circuit is first analyzed by circuit simulation software, at initial treble, middle, and bass settings, and magnitude and phase responses versus frequency are generated. Values of gains, zeroes and poles are then chosen for the low-pass and high-pass filters of the analog filter approximation, in order to produce magnitude and phase versus frequency responses that match as closely as possible to the responses of the desired analog tone control circuit. A bilinear transformation is then performed to produce a digital filter model. Update equations responsive to treble, middle, and bass settings of the desired tone control circuit are then designed so that the digital filter parameters can be adjusted as a function of updates in the treble, middle, and bass settings of the desired simulated tone control circuit

Filters designed in accordance with the present invention, have been found to accurately model the magnitude and phase response of the desired analog tone control circuits. In addition, this model can be precisely implemented using realizable digital filters which can be updated by update equations to produce near exact magnitude and phase responses for a wide range of tone control circuits, for all possible combinations of tone control settings. Finally this method enables a programmable amplifier to be manufactured, which in a single unit can accurately model the magnitude and phase frequency responses of a wide range of analog tone control circuits.

### BRIEF DESCRIPTION OF THE SEVERAL VIEWS OF THE DRAWINGS

A more complete understanding of the invention can be obtained by considering the following detailed description in conjunction with the accompanying drawings, in which:

FIG. 1 is a simplified schematic diagram of a conventional analog tone control circuit for controlling the frequency response of audio amplifiers, known to the prior art;

FIG. 2 is a simplified schematic diagram of a conventional analog tone control circuit for controlling the frequency response of audio amplifiers, known to the prior art;

FIG. 3 is a simplified schematic diagram of a conventional analog tone control circuit for controlling the frequency response of audio amplifiers another known tone control circuit, known to the prior art;

FIG. 4 is a simplified schematic diagram of a conventional analog tone control circuit for controlling the frequency response of audio amplifiers another known tone control circuit, known to the prior art;

FIG. 5 is a chart showing the frequency response of a prior art conventional analog tone control circuit for a particular setting of the tone controls;

FIG. 6 is a chart showing the phase response of a prior art conventional analog tone control circuit for a particular setting of the tone controls;

FIG. 7 is a simplified schematic diagram of a low-pass filter used in the present invention as part of the approximate model of the circuit of

FIG. 8 is a simplified schematic diagram of a high-pass filter used in the present invention as part of the approximate model of the circuit of FIG. 1;

FIG. 9 is a simplified diagram of the analog filter model in accordance with the present invention, along with the mathematical expressions characterizing each filter in terms of one pole, one zero, and gain;

FIG. 10 is a digital filter computed from the model depicted in FIG. 9, along with the mathematical expressions characterizing the filter;

FIG. 11 is a diagram of the steps that summarize the complete filter design method for implementing the present invention;

FIG. 12 is the set of update equations referred to in FIG. 11, by which the digital filter coefficients and gains, as a function of the treble, middle, and bass controls, are adjusted;

FIG. 13 is a simplified diagram of the mathematical functions of a digital filter in accordance with the present invention;

FIG. 14 is a simplified block diagram showing the circuit functions of a digital filter in accordance with the present invention.

### DETAILED DESCRIPTION OF THE INVENTION

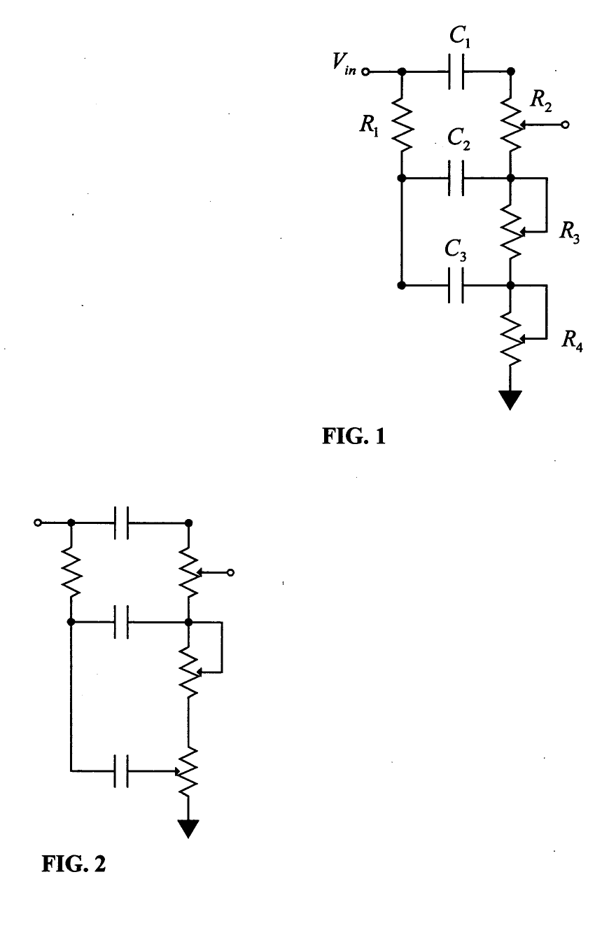

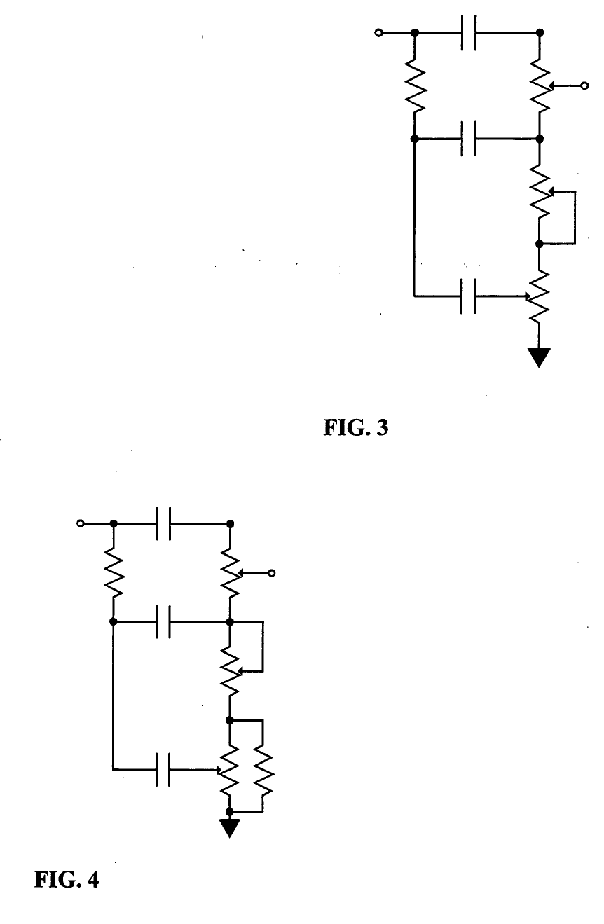

FIG. 1 is a schematic of a tone control circuit that has been in use in the prior art for many years. The original form and a number of variations are illustrated in FIG. 2, FIG. 3, and FIG. 4. FIG. 1 , the original, and the variations such as the ones shown in FIG. 2, FIG. 3, and FIG. 4., including various combinations of component values, have made up the bulk of the prior art analog tone control circuits in use in guitar amplifiers, and the like. As discussed above, each change in component value or wiring configuration produces unique tonal characteristics because the components interact in the circuit in many ways, making simulation difficult.

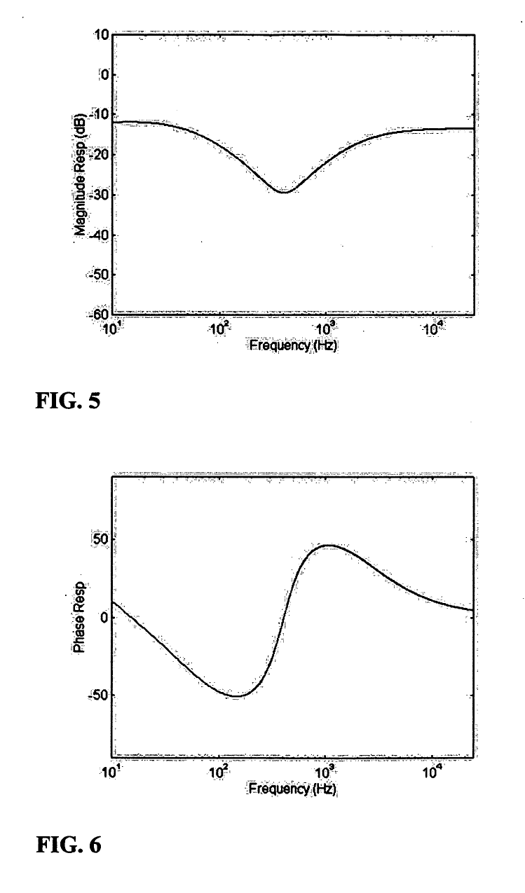

The frequency response of the tone control circuit of FIG. 1, is plotted in FIG. 5 and FIG. 6. FIG. 5 plots the magnitude response, and FIG. 6 plots the phase response. These plots are generated using commercially available circuit simulation software. The magnitude response shows broad based bass and treble peaks separated by a mid range valley. The phase response shows a clear shift from negative to positive phase, which occurs in the mid range. This is an important characteristic of the tone control circuit, however, the phase response is often ignored.

Pritchard, U.S. Pat. No. 4,117,413, for example, describes the importance of the phase response of a filter circuit. However, Curtis, U.S. Pat. No. 6,222,110 B1, appears not to be concerned to control the phase of the signal, does not address the phase response of tone control circuits, and does not mention control of the phase of signals as being an objective of the invention.

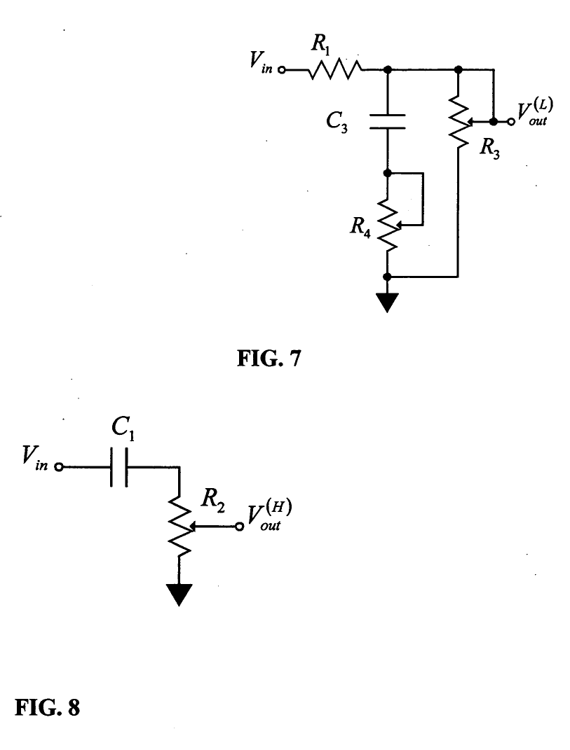

The present invention models the circuit of FIG. 1, as an approximation, as the sum of a low-pass filter, illustrated in FIG. 7, and a high-pass filter, illustrated in FIG. 8. These models assume that C₂ is a large capacitor compared with the other elements for the frequency range of interest, 20 Hz to 20 kHz. As a result this capacitor is replaced in the approximate circuit with a wire connection. In addition, the resistance of the bass control, R₃, is typically much larger than the resistance of the middle control, R₄. As a result, the bass control is wired to ground, in the approximate circuit shown in FIG. 7.

As another element of the approximation, the interactions between the circuit elements of FIG. 7 and FIG. 8 are ignored.

FIG. 7 shows the low-pass filter approximation. In this circuit, a pole is created from the interaction of R₁, R₃, and C₃. The pole increases in frequency as the bass control, R₃, is decreased. In addition, R₃ determines the gain of the output of the low-pass filter. Another feature of this circuit is the zero created by the interaction of R₄ and C₃. As the mid control, R₄, increases, the zero is decreased in frequency, which changes the depth of the mid range valley.

FIG. 8 shows the high-pass filter approximation. In this circuit, a zero exists at 0 Hz, and a pole is created from the interaction of C₁ and R₂. In addition, R₂ determines the gain of the high-pass filter output.

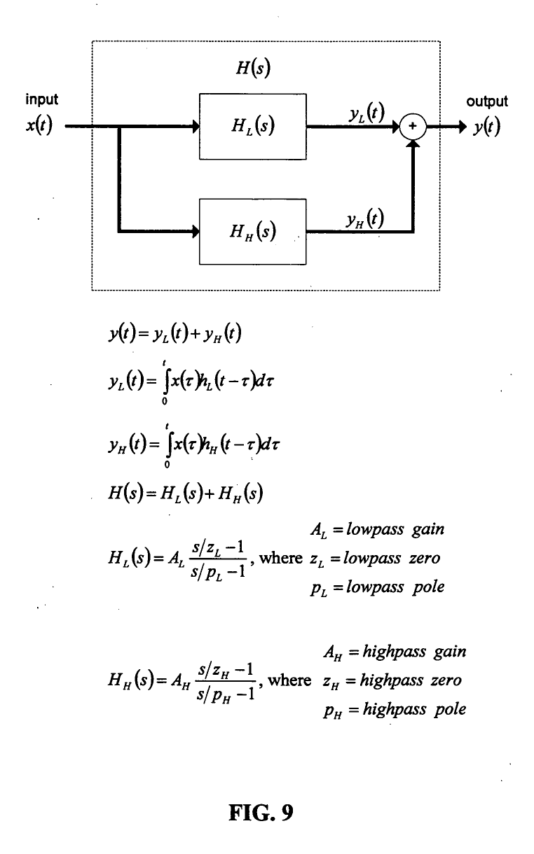

Summing the high-pass and low-pass filters together produces the analog filter model shown in FIG. 9. As seen in FIG. 9, each filter has one pole, one zero, and gain. Experiments show that this model produces a frequency response very similar to the analog tone control circuit, in terms of the magnitude and phase response. As the tone controls are tuned, the gains, poles, and zeros of the analog filter model change, accurately modeling the behavior of the analog tone control circuit. The analog filter model of FIG. 9 has a simple mathematical expression to characterize each filter in terms of one pole, one zero, and gain.

A new digital filter can be derived from the analog filter model of FIG. 9, by applying the bilinear transformation, defined below;
H(Z)=H(s)|_{s=2*F}_{ₛ}_{*(Z-1)/(Z+1)},
where, Fₛ is the sampling rate for the digital filter.

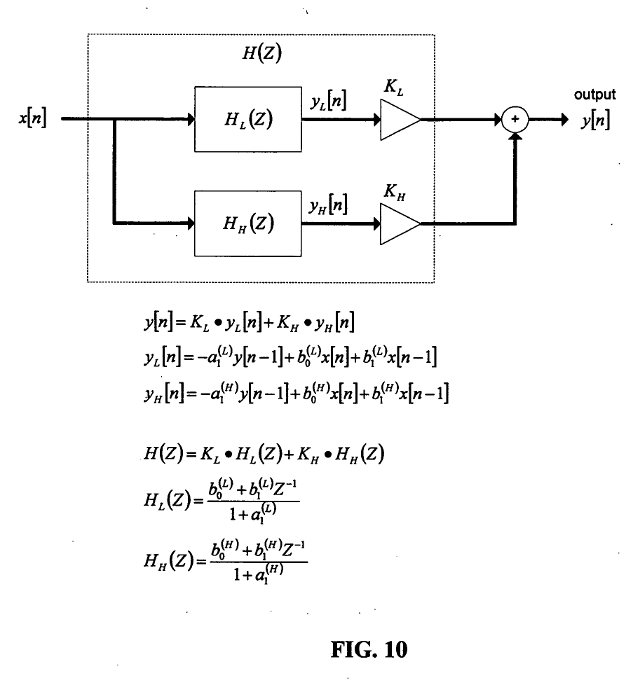

The computed digital filter is illustrated in FIG. 10. It is important to note that each digital filter in FIG. 10 also has one pole, one zero, and gain. In addition, experiments show that the digital filters produce a near perfect match to the response of the analog filter in FIG. 9, in terms of the magnitude and phase frequency response. A final important result is that the digital filter, illustrated in FIG. 10, is completely specified for realization in a digital signal processor, or general-purpose microprocessor, to someone skilled in the art of digital signal processing.

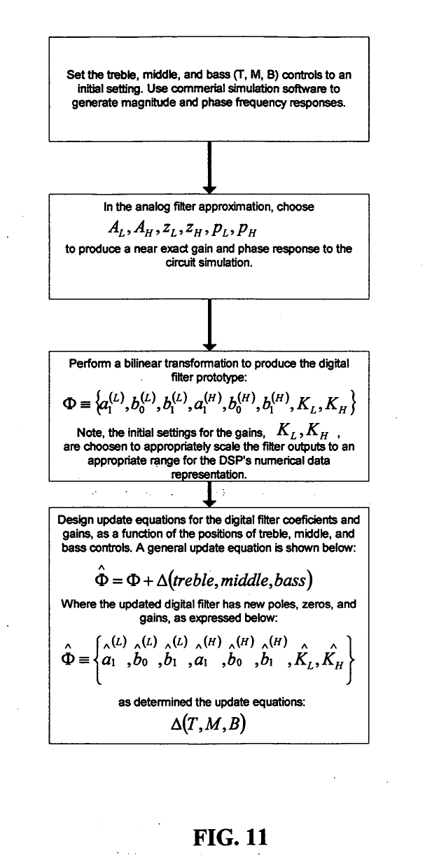

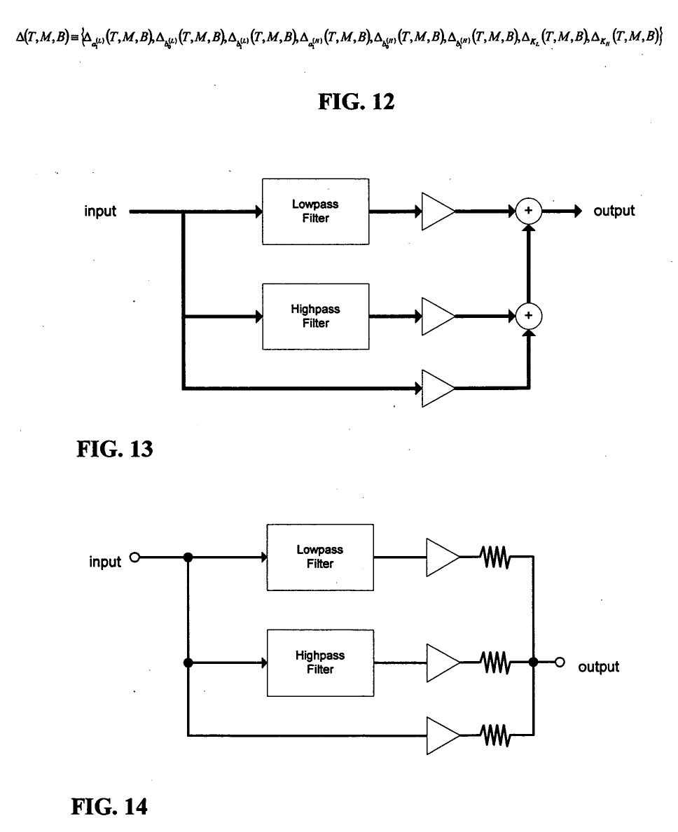

An important result of the invention is that the gain, poles, and zeros of the digital filters, illustrated in FIG. 10, are easily modified to match the magnitude and phase response of the analog tone control circuit, as a function of the treble, middle, and bass control settings. This is achieved using update equations as illustrated in FIG. 11 and FIG. 12.

FIG. 11 summarizes the complete filter design method for implementing this invention for each desired tone control circuit.

Referring now to the steps of FIG. 11, first, commercial circuit simulation software generates the magnitude and phase frequency response of the tone control circuit, tuned to initial settings of the treble, middle, and bass controls.

Next, a low-pass and a high-pass analog filter are designed to match the magnitude and phase frequency response of the circuit simulation. If the commercial circuit simulation software is not available, then the low-pass and high-pass filters can be designed by choosing the poles, zeros, and gains from the approximation circuits of FIG. 7 and FIG. 8.

Next, a bilinear transform produces digital filters, equivalent to the analog filters. The resulting digital filter coefficients and gains are stored as a prototype for the desired tone control circuit.

Next, update equations are designed to adjust the digital filter coefficients and gains, as a function of the treble, middle, and bass controls, as illustrated in FIG. 12. These update equations allow complete control of the digital filters' gains, poles and zeros, implementing the behavior of the analog tone control circuit in terms of the interactions between the circuit elements. In addition, the update equations can correct some behavior which is not accurately modeled by the analog filter model of FIG. 9.

The design method of FIG. 11 is repeated for each desired analog tone control circuit implemented in the programmable amplifier. Thus, the programmable amplifier stores one filter prototype and one set of update equations for each modeled tone control circuit.

FIG. 13 and FIG. 14 are simplified diagrams illustrating the functions of the circuits that embody a digital tone control filter in accordance with the present invention. FIG. 13 is a flow diagram containing a mathematical illustration of a digital tone control filter in accordance with the present invention, while FIG. 14 provides, in the form of a simplified block diagram, an electrical circuit illustration of the tone control circuit of the present invention.

As a result of this invention, a programmable amplifier can be manufactured to model a wide range of analog tone control circuits, with a near exact frequency magnitude and phase response.

Although the present invention has been described in connection with specific examples, it will be appreciated by those skilled in the art that the present invention is not limited merely to those specifics shown. Variations and modifications can be made without departure from the spirit of the present invention. It may be desirable in some cases to use more than the low-pass and high-pass filters shown, for example, and to sum the outputs of the filters in other combinations than shown. These variations are specifically contemplated. Accordingly, variation of the preferred form and the particulars as described for the present invention may be undertaken without departure from the scope of the invention, which is defined only by the claims which follow.

1. A method for programming programmable digital computation means, such as a programmable digital signal processor or a microprocessor, to produce a digital filter having response characteristics equivalent to those of a desired analog tone control circuit, said tone control circuit having at least one adjustable tone control for controlling treble, middle or bass frequencies, said method comprising the following steps:
(a) simulating the analog tone control circuit by an equivalent circuit comprising low-pass and high-pass filters having outputs summed, and each filter having adjustable gain, zeroes, and poles;
(b) selecting initial settings of the treble, middle and bass controls of the simulated analog tone control circuit;
(c) using simulation software, generating magnitude and phase frequency responses for the desired analog tone control circuit circuits at the selected settings;
(d) choosing gain, zero, and pole values for the equivalent circuit such that the gain and phase responses of the equivalent circuit match as exactly as possible the gain and phase responses provided by the circuit simulation computer program;
(e) performing a bilinear transformation to produce a digital filter prototype
(f): designing update equations for the digital filter gains, poles and zeroes, such that changing the values for the simulated treble, middle and bass controls produces corresponding changes in the values of the digital filter gains, poles and zeroes.

2. A programmable tone control circuit for shaping the frequency response characteristics of an audio amplifier of the type intended to provide amplification for musical instruments and the like, to simulate the action of a desired analog tone control circuit, comprising:
programmable digital computation means, programmed to simulate digital low pass filter and digital high pass filter circuits having summed outputs, said filters having programmable gains, zeroes, and poles;
means for selecting tone settings for the desired analog tone control circuit;
digital computation means, responsive to the means for selecting desired tone settings, for computing incremental adjustments to the values for the programmable gains, zeroes, and poles corresponding to the tone settings selected for the desired analog tone control circuit.

3. The apparatus of claim 2 wherein the programmable digital computation means is a programmable digital signal processor.

4. The apparatus of claim 2 wherein the programmable digital computation means is a programmable microprocessor.

5. The apparatus of claim 2 wherein the computation means is further programmed to cause the gain, zeroes, and poles of the digitally simulated low-pass and high-pass filters to have values that match the frequency and phase response of the simulated analog tone
